(19) United States
(12) Patent Application Publication
(10) Pub. No.: US 2023/0299344 A1
(43) Pub. Date: Sep. 21, 2023

(54) LITHIUM METAL SECONDARY BATTERY AND GEL ELECTROLYTE

(71) Applicant: HONDA MOTOR CO., LTD., Tokyo (JP)

(72) Inventors: Tomohiro KINOSHITA, Saitama (JP); Taku OWADA, Saitama (JP)

(21) Appl. No.: 18/172,327

(22) Filed: Feb. 22, 2023

(30) Foreign Application Priority Data
Mar. 18, 2022 (JP) 2022-044102

(51) Int. Cl. H01M 10/0565; H01M 4/04; H01M 4/40

(52) U.S. Cl. CPC H01M 10/0565; H01M 4/0404; H01M 4/405; H01M 2004/027

(57) ABSTRACT

To provide a lithium metal secondary battery including a gel electrolyte layer between a positive electrode and a negative electrode, the positive electrode including a positive electrode current collector and a positive electrode mixture layer containing a lithium composite oxide, the negative electrode including a negative electrode current collector, the gel electrolyte layer including: a gelation agent utilizing a π-π stacking interaction and an electrolytic solution, the gelation agent having a perfluoroalkyl group and a phenylene group.

This application is based on and claims the benefit of priority from Japanese Pat. Application 2022-044102, filed on 18 Mar. 2022, the content of which is incorporated herein by reference.

### BACKGROUND OF THE INVENTION

### Field of the Invention

The present invention relates to a lithium metal secondary battery and a gel electrolyte.

### Related Art

From the viewpoint of climate-related disasters, there is a growing interest in electric vehicles due to the need to reduce CO₂ emissions. A lithium metal secondary battery with high energy density is being considered as an example of a secondary battery to be installed in electric vehicles.

There has been known, as a lithium metal secondary battery, a lithium metal secondary battery including a positive electrode including a positive electrode current collector and a positive electrode mixture layer containing a lithium composite oxide; a negative electrode including a negative electrode current collector; and a solid electrolyte layer; the lithium metal secondary battery further including a gel electrolyte layer containing a polymer compound having a gelation function and an electrolytic solution between the negative electrode current collector and the solid electrolyte layer (see Patent Document 1).

Patent Document 1: Japanese Unexamined Pat. Application, Publication No. 2018-206757

### SUMMARY OF THE INVENTION

However, it has been known that the cell resistance increases because the gel electrolyte layer contains a polymer compound having a gelation function.

Therefore, although it is considered to use a gelation agent in which a Π-Π stacking interaction is utilized in place of the polymer compound having a gelation function, a solvation structure of an electrolytic solution changes depending on the amount of the gelation agent added, leading to deterioration of the durability of the lithium metal secondary battery.

It is an object of the present invention to provide a lithium metal secondary battery capable of improving the durability without changing a solvation structure of an electrolytic solution even when using a gelation agent in which a Π-Π stacking interaction is utilized.

In accordance with one aspect of the present disclosure, there is provided a lithium metal secondary battery including: a gel electrolyte layer between a positive electrode and a negative electrode, the positive electrode including a positive electrode current collector and a positive electrode mixture layer containing a lithium composite oxide, the negative electrode including a negative electrode current collector, the gel electrolyte layer containing: a gelation agent utilizing a _{Π}-_{Π} stacking interaction and an electrolytic solution, the gelation agent having a perfluoroalkyl group and a phenylene group.

The lithium metal secondary battery may further include a solid electrolyte layer between the positive electrode and the negative electrode, and the gel electrolyte layer may be disposed between the negative electrode and the solid electrolyte layer.

The negative electrode may further include a lithium metal layer.

The electrolytic solution may include dimethyl carbonate and lithium bis(fluorosulfonyl)imide, and a molar ratio of dimethyl carbonate to lithium bis(fluorosulfonyl)imide may be 1.1 or more and 3.0 or less.

In accordance with another aspect of the present disclosure, there is provided a gel electrolyte, containing: a gelation agent utilizing a _{Π}-_{Π} stacking interaction, and an electrolytic solution, the gelation agent having a perfluoroalkyl group and a phenylene group.

According to the present invention, it is possible to provide a lithium metal secondary battery capable of improving the durability without changing a solvation structure of an electrolytic solution even when using a gelation agent in which a Π-Π stacking interaction is utilized.

### BRIEF DESCRIPTION OF THE DRAWINGS

The FIGURE is a cross-sectional view showing an example of a lithium metal secondary battery of the present embodiment.

### DETAILED DESCRIPTION OF THE INVENTION

Hereinafter, embodiments of the present invention will be described.

### Lithium Metal Secondary Battery

The lithium metal secondary battery of the present embodiment includes a gel electrolyte layer between a positive electrode and a negative electrode. Here, the positive electrode includes a positive electrode current collector and a positive electrode mixture layer containing a lithium composite oxide. The negative electrode includes a negative electrode current collector and a lithium metal layer.

That is, when charging the lithium metal secondary battery of the present embodiment, lithium metal is deposited on the negative electrode, and when discharging, lithium ions are eluted from the negative electrode. Therefore, in the lithium metal secondary battery of the present embodiment, the negative electrode may not include a lithium metal layer in an initial state. In this case, by charging a lithium metal secondary battery before using the lithium metal secondary battery, lithium metal is deposited on a negative electrode current collector to form a lithium metal layer.

The gel electrolyte layer (composed of a gel electrolyte) contains a gelation agent utilizing a Π-Π stacking interaction and an electrolytic solution, the gelation agent having a perfluoroalkyl group and a phenylene group. Thereby, when charging the lithium metal secondary battery, reductive decomposition of the gelation agent in which a Π-Π stacking interaction is utilized is suppressed, leading to an improvement in durability of the lithium metal secondary battery. The lithium metal secondary battery of the present embodiment is capable of improving the durability by using the gelation agent in which a _{Π}-_{Π} stacking interaction is utilized without changing a solvation structure.

Specific examples of a compound represented by the general formula (1) include compounds represented by the following chemical formulas.

### [Chem. 1]

wherein a, b and n each independently represent a positive integer.

The content of the gelation agent in which a _{Π}-_{Π} stacking interaction is utilized in the gel electrolyte is preferably 0.5% by mass or more and 2% by mass or less. If the content of the gelation agent in which a Π-Π stacking interaction is utilized in the gel electrolyte is 0.5% by mass or more, when charging the lithium metal secondary battery, dendrite growth is suppressed, leading to an improvement in durability of the lithium metal secondary battery, and if the content is 2% by mass or less, the durability of the lithium metal secondary battery of the present embodiment is improved without changing a solvation structure of the electrolytic solution.

The electrolytic solution is not particularly limited as long as it has lithium ion conductivity and can undergo gelation by a gelation agent utilizing a _{Π}-_{Π} stacking interaction and having a phenylene group and a perfluoroalkyl group.

It is preferred that the electrolytic solution contains dimethyl carbonate and lithium bis(fluorosulfonyl)imide. In this case, a molar ratio of dimethyl carbonate to lithium bis(fluorosulfonyl)imide is preferably 1.1 or more and 3.0 or less, and more preferably 1.1 or more and 2.5 or less. If the molar ratio of dimethyl carbonate to lithium bis(fluorosulfonyl)imide is 1.1 or more, the solubility of lithium bis(fluorosulfonyl)imide in dimethyl carbonate is improved, and if the molar ratio is 3.0 or less, when charging the lithium metal secondary battery, dendrite growth is suppressed, leading to an improvement in the durability of the lithium metal secondary battery.

The thickness of the gel electrolyte layer is not particularly limited and is, for example, 0.1 µm or more and 20 µm or less.

Examples of the positive electrode current collector include, but are not particularly limited to, an aluminum foil and the like.

The thickness of the positive electrode current collector is not particularly limited and is, for example, 12 µm or more and 22 µm or less.

The positive electrode mixture layer contains lithium composite oxide and may further contain other components.

Examples of the lithium composite oxide include, but are not particularly limited to, LiCoO₂, Li (Ni_{5/10}Co_{2/10}Mn_{3/10}) O₂, Li (Ni_{6/10}Co_{2/10}Mn_{2/10}) O₂, Li (Ni_{8/10}Co_{⅒}Mn_{⅒}) O₂, Li (Ni_{0.8}C_{O0.15}Al₀.₀₅) O₂, Li (Ni_{⅙}Co_{4/6}Mn_{⅙}) O₂, Li (Ni_{⅓}Co_{⅓}Mn_{⅓}) O₂, LiCoO₄, LiMn₂O₄, LiNiO₂, LiFePO₄ and the like, and two or more thereof may be used in combination.

The content of the lithium composite oxide in the positive electrode mixture layer is not particularly limited and is, for example, 60% by mass or more and 98.5% by mass or less.

Examples of other components include positive electrode active materials other than the lithium composite oxide, conductive aids, binders and the like.

The thickness of the positive electrode mixture layer is not particularly limited and is, for example, 50 µm or more and 100 µm or less.

Examples of the negative electrode current collector include, but are not particularly limited to, a copper foil and the like.

The thickness of the negative electrode current collector is not particularly limited and is, for example, 1 µm or more and 20 µm or less.

The thickness of the lithium metal layer is not particularly limited and is, for example, 80 µm or less.

It is possible to produce a lithium metal secondary battery of the present embodiment using a known method.

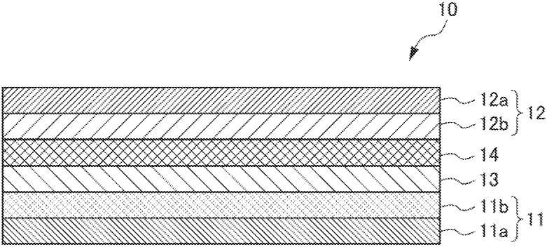

FIG. 1 shows an example of a lithium metal secondary battery of the present embodiment.

A lithium metal secondary battery 10 includes a solid electrolyte layer 13 between a positive electrode 11 and a negative electrode 12, and includes a gel electrolyte layer 14 between the negative electrode 12 and the solid electrolyte layer 13. Here, the positive electrode 11 includes a positive electrode current collector 11a and a positive electrode mixture layer 11b containing a lithium composite oxide, and the negative electrode 12 includes a negative electrode current collector 12a and a lithium metal layer 12b. In addition, the gel electrolyte layer 14 contains a gelation agent utilizing a Π-Π stacking interaction and an electrolytic solution, the gelation agent having a perfluoroalkyl group and a phenylene group.

The solid electrolyte constituting the solid electrolyte layer 13 is not particularly limited as long as it has lithium ion conductivity, and examples thereof include an oxide-based electrolyte, a sulfide-based electrolyte and the like.

The thickness of the solid electrolyte layer 13 is not particularly limited and is, for example, 5 nm or more and 20 µm or less.

The negative electrode 12 may not include a lithium metal layer 12b in an initial state.

The solid electrolyte layer 13 may be omitted. In this case, the gel electrolyte layer 14 functions as a separator.

While embodiments of the present invention have been described, the present invention is not limited to the above embodiments and the above embodiments may be appropriately varied within the spirit of the present invention.

### EXAMPLES

Examples of the present invention will be described below, but the present invention is not limited to the following Examples.

### Example 1

lithium-nickel-cobalt-manganese composite oxide as a lithium composite oxide, acetylene black as a conductive aid, and polyvinylidene fluoride as a binder were mixed to obtain a coating solution for positive electrode mixture layer.

An Al foil having a surface area of 12 cm² and a thickness of 15 µm as a positive electrode current collector was coated with the coating solution for positive electrode mixture layer, followed by drying to form a positive electrode mixture layer of 20 mg/cm² and further rolling, thus obtaining a positive electrode.

As the negative electrode current collector and the solid electrolyte layer, a Cu foil having a surface area of 12 cm² and a thickness of 12 µm and a porous polyolefin film having a surface area of 12 cm² and a thickness of 20 µm were respectively used.

Dimethyl carbonate and lithium bis(fluorosulfonyl)imide were mixed at a molar ratio of dimethyl carbonate to lithium bis(fluorosulfonyl)imide of 2 to obtain an electrolytic solution.

The electrolytic solution and a compound represented by the following chemical formula as a gelation agent in which a _{Π}-_{Π} stacking interaction is utilized were mixed so that the content of the gelation agent in which a _{Π}-_{Π} stacking interaction is utilized became 1% by mass (see Table 1), followed by dissolution while stirring at 80° C. for 12 hours to obtain a gel electrolyte layer.

### [Chem. 2]

he positive electrode, the solid electrolyte layer, the gel electrolyte layer and the negative electrode current collector were stacked in this order, followed by sealing with a laminated film to obtain a lithium metal secondary battery.

### [Durability of Lithium Metal Secondary Battery]

he charging capacity per unit area of the positive electrode was defined as 3.78 mAh/cm², and then the durability was evaluated by carrying out a cycle test of the lithium metal secondary battery under the following conditions. The lithium metal secondary battery was incorporated into a jig, and after confining under a confining pressure of 0.05 MPa, aging was carried out at 0.1 C for 3 cycles to obtain initial characteristics at 25° C. A cycle test was then carried out at 45° C. under the conditions of charging at 0.3 CCV and discharging at 0.3 C.

The current value at which discharging can be completed in 1 hour was defined as 1 C for the discharge capacity of the positive electrode.

The evaluation results of the durability of the lithium metal secondary battery are shown in Table 1. Here, the capacity retention rate means a ratio of the capacity in the 1st cycle and the capacity after carrying out 20 cycles.

TABLE 1

| | Content of elation agent [% by mass] | Capacity retention rate [%] |
|---|---|---|
| Example 1 | 1 | 99.1 |

As is apparent from Table 1, the lithium metal secondary battery of Example 1 has high capacity retention rate and high durability.

EXPLANATION OF REFERENCE NUMERALS

| | |
|---|---|
| 10 | Lithium metal secondary battery |
| 11 | Positive electrode |
| 11 a | Positive electrode current collector |
| 11 b | Positive electrode mixture layer |
| 12 | Negative electrode |
| 12 a | Negative electrode current collector |
| 12 b | Lithium metal layer |
| 13 | Solid electrolyte layer |
| 14 | Gel electrolyte layer |

What is claimed is:

1. A lithium metal secondary battery comprising a gel electrolyte layer between a positive electrode and a negative electrode,
the positive electrode comprising a positive electrode current collector and a positive electrode mixture layer containing a lithium composite oxide,
the negative electrode comprising a negative electrode current collector,
the gel electrolyte layer comprising:
a gelation agent utilizing a Π-Π stacking interaction, and
an electrolytic solution,
the gelation agent having a perfluoroalkyl group and a phenylene group.

2. The lithium metal secondary battery according to claim 1, further comprising a solid electrolyte layer between the positive electrode and the negative electrode,
wherein the gel electrolyte layer is disposed between the negative electrode and the solid electrolyte layer.

3. The lithium metal secondary battery according to claim 1, wherein the negative electrode further comprises a lithium metal layer.

4. The lithium metal secondary battery according to claim 1, wherein the electrolytic solution comprises dimethyl carbonate and lithium bis(fluorosulfonyl)imide, and a molar ratio of dimethyl carbonate with respect to lithium bis(fluorosulfonyl)imide is 1.1 or more and 3.0 or less.

5. A gel electrolyte comprising: a gelation agent utilizing a Π-Π stacking interaction, and
an electrolytic solution,
the gelation agent having a perfluoroalkyl group and a phenylene group.
